(19) United States
(12) Patent Application Publication
(10) Pub. No.: US 2026/0036323 A1
(43) Pub. Date: Feb. 5, 2026

(54) INDOOR CAMERA OR OTHER MICROPHONE DETERMINING OCCUPANCY TO ADJUST A THERMOSTAT

(71) Applicant: Vivint LLC, Provo, UT (US)

(72) Inventors: Rongbin Lanny Lin, Provo, UT (US); Brandon Bunker, Provo, UT (US); Justin Tran, Provo, UT (US); Christopher Hall, Provo, UT (US); Erik Swenson, Provo, UT (US); Conner Mickelson, Provo, UT (US); Nathan Maus, Provo, UT (US)

(73) Assignee: Vivint LLC, Provo, UT (US)

(21) Appl. No.: 19/289,240

(22) Filed: Aug. 4, 2025

Related U.S. Application Data
(60) Provisional application No. 63/678,636, filed on Aug. 2, 2024.

(51) Int. Cl. F24F 11/63; F24F 120/10; G06V 20/52; G06V 40/10; G10L 25/51

(52) U.S. Cl. CPC F24F 11/63; G06V 20/52; G06V 40/10; F24F 2120/10; G10L 25/51

(57) ABSTRACT

Presented herein are systems and methods for determining occupancy to adjust a thermostat. The system can include an indoor camera that can monitor an indoor environment. The indoor camera can capture audio data and visual data. The indoor camera can include one or more processors coupled with non-transitory memory to determine, by analyzing audio data or video data captured by the indoor camera, occupancy state of the indoor environment; and to transmit a message to the automation application. The message may indicate the occupancy state of the indoor environment. The automation application can adjust a thermostat upon receiving the message having a particular occupancy state of the indoor environment.

### CROSS REFERENCE TO RELATED APPLICATION

This application is a claims priority to U.S. Patent Application Ser. No. 63/678,636, filed Aug. 2, 2024, the entire contents of which are hereby incorporated by reference as though fully set forth herein.

### TECHNICAL FIELD

This application generally relates to smart home systems capable of determining occupancy and adjusting thermostat settings or other smart home devices.

### BACKGROUND

Traditional methods for determining occupancy within a home or building often rely on simple motion detectors, timers, or manual input. These methods can be imprecise, failing to accurately detect whether the space is occupied by humans as opposed to pets. Moreover, these systems do not account for audio cues that may indicate presence more subtly than visual movement. There exists a need for an improved occupancy detection system that utilizes both audio and visual indicators to manage home devices such as thermostats for optimized energy use and enhanced privacy.

### SUMMARY

The disclosure relates to a smart environmental control system designed to enhance the automation of indoor climate and energy management based on occupancy detection. An indoor camera system can utilize video and audio data to enhance occupancy detection within a smart home environment. The indoor camera can determine or discern various types of audio cues, such as footsteps, conversations, and household sounds, which, when coupled with visual detection of movement, can determine the presence and activity level of people, and may even distinguish a person from a pet. The data can be integrated into models of home occupancy. Occupancy data can be used to control thermostats or other smart devices, thereby optimizing electricity usage and cost savings.

The system can include an indoor camera paired with an automation application to monitor and respond to the occupancy state of an indoor environment. The indoor camera can include one or more processors and non-transitory memory that work together to capture and analyze both audio and visual data within the indoor environment. This analysis can determine whether the space is occupied and to what extent. The indoor camera can include privacy-preserving features that address consumer concerns. Privacy measures can include a mode that halts audio and video recording or processes the data to obscure faces and alter voices, ensuring that personal privacy is maintained while still allowing for the use of occupancy data in adjusting the thermostat or enhancing smart home automation.

In an embodiment, a system can include an indoor camera that can monitor an indoor environment. The indoor camera can capture audio data and visual data. The indoor camera can include one or more processors coupled with non-transitory memory to determine, by analyzing audio data or video data captured by the indoor camera, occupancy state of the indoor environment; and to transmit a message to the automation application. The message may indicate the occupancy state of the indoor environment. The automation application can adjust a thermostat upon receiving the message having a particular occupancy state of the indoor environment. The indoor camera can differentiate between human and non-human activity based on the audio data or video data, and the occupancy state determined can take into account only human presence within the indoor environment.

### BRIEF DESCRIPTION OF THE DRAWINGS

The accompanying drawings constitute a part of this specification, illustrate an embodiment, and, together with the specification, explain the subject matter of the disclosure.

FIG. 1 illustrates an example system architecture of a structure, according to an embodiment.

FIG. 2 illustrates an indoor camera in an indoor environment, according to an embodiment.

FIG. 3 illustrates an indoor camera in an indoor environment, according to an embodiment.

### DETAILED DESCRIPTION

Reference will now be made to the embodiments illustrated in the drawings, and specific language will be used here to describe the same. It will nevertheless be understood that no limitation of the scope of the disclosure is thereby intended. Alterations and further modifications of the features illustrated here, and additional applications of the principles as illustrated here, which would occur to a person skilled in the relevant art and having possession of this disclosure, are to be considered within the scope of the disclosure.

Disclosed herein are systems and methods for determining occupancy to adjust a thermostat. For example, if the system knows that the user will not be home, the system can adjust the thermostat settings to conserve energy while ensuring the home environment is comfortable upon the user's return. The methods can include various techniques for occupancy detection, such as motion sensors, indoor cameras, mobile device location tracking, or scheduling algorithms that predict the user's patterns based on historical data. Once occupancy is determined, the thermostat can be adjusted to a pre-set temperature that optimizes energy consumption and comfort. The system can include user interfaces, such as mobile apps or web applications, allowing the user to manually override automatic settings or adjust preferences. The system can also integrate with other smart home devices for comprehensive home automation, enhancing user convenience and further optimizing energy usage.

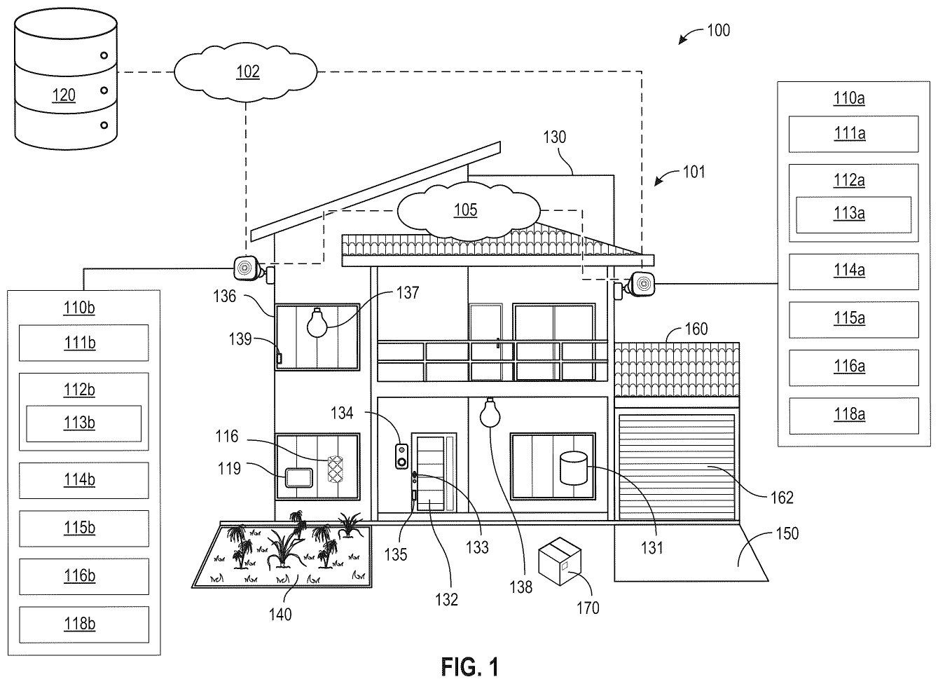

FIG. 1 illustrates an example environment 100, such as a residential property, in which the present systems and methods may be implemented. The environment 100 may include a site that can include one or more structures, any of which can be a structure or building 130, such as a home, office, warehouse, garage, and/or the like. The building 130 may include various entryways, such as one or more doors 132, one or more windows 136, and/or a garage 160 having a garage door 162. The environment 100 may include multiple sites. In some implementations, the environment 100 includes multiple sites, each corresponding to a different property and/or building. In an example, the environment 100 may be a cul-de-sac that includes multiple buildings 130.

A first camera 110a and a second camera 110b, referred to herein collectively as cameras 110, may be disposed at the environment 100, such as outside and/or inside the building 130. The cameras 110 may be attached to the building 130, such as at a front door of the building 130 or inside of a living room. The cameras 110 may communicate with each other over a local network 105. The cameras 110 may communicate with a server 120 over a network 102. The local network 105 and/or the network 102, in some implementations, may each include a digital communication network that transmits digital communications. The local network 105 and/or the network 102 may each include a wireless network, such as a wireless cellular network, a local wireless network, such as a Wi-Fi network, a Bluetooth® network, a near-field communication (“NFC”) network, an ad hoc network, and/or the like. The local network 105 and/or the network 102 may each include a wide area network (“WAN”), a storage area network (“SAN”), a local area network (“LAN”) (e.g., a home network), an optical fiber network, the internet, or other digital communication network. The local network 105 and/or the network 102 may each include two or more networks. The network 102 may include one or more servers, routers, switches, and/or other networking equipment. The local network 105 and/or the network 102 may also include one or more computer readable storage media, such as a hard disk drive, an optical drive, non-volatile memory, RAM, or the like.

The local network 105 and/or the network 102 may be a mobile telephone network. The local network 105 and/or the network 102 may employ a Wi-Fi network based on any one of the Institute of Electrical and Electronics Engineers (“IEEE”) 802.11 standards. The local network 105 and/or the network 102 may employ Bluetooth® connectivity and may include one or more Bluetooth connections. The local network 105 and/or the network 102 may employ Radio Frequency Identification (“RFID”) communications, including RFID standards established by the International Organization for Standardization (“ISO”), the International Electrotechnical Commission (“IEC”), the American Society for Testing and Materials® (“ASTM®”), the DASH7™ Alliance, and/or EPCGlobal™.

In some implementations, the local network 105 and/or the network 102 may employ ZigBee® connectivity based on the IEEE 802 standard and may include one or more ZigBee connections. The local network 105 and/or the network 102 may include a ZigBee® bridge. In some implementations, the local network 105 and/or the network 102 employs Z-Wave® connectivity as designed by Sigma Designs® and may include one or more Z-Wave connections. The local network 105 and/or the network 102 may employ an ANT® and/or ANT+® connectivity as defined by Dynastream® Innovations Inc. of Cochrane, Canada and may include one or more ANT connections and/or ANT+ connections.

The first camera 110a may include an image sensor 115a, a processor 111a, a memory 112a, a depth sensor 114a (e.g., radar sensor 114a), a speaker 116a, and a microphone 118a. The memory 112a may include computer-readable, non-transitory instructions which, when executed by the processor 111a, cause the processor 111a to perform methods and operations discussed herein. The processor 111a may include one or more processors. The second camera 110b may include an image sensor 115b, a processor 111b, a memory 112b, a radar sensor 114b, a speaker 116b, and a microphone 118b. The memory 112b may include computer-readable, non-transitory instructions which, when executed by the processor 111b, cause the processor to perform methods and operations discussed herein. The processor 111a may include one or more processors.

The memory 112a may include an AI model 113a. The AI model 113a may be applied to or otherwise process data from the camera 110a, the radar sensor 114a, and/or the microphone 118a to detect and/or identify one or more objects (e.g., people, animals, vehicles, shipping packages or other deliveries, or the like), one or more events (e.g., arrivals, departures, weather conditions, crimes, property damage, or the like), and/or other conditions. For example, the cameras 110 may determine a likelihood that an object 170, such as a package, vehicle, person, or animal, is within an area (e.g., a geographic area, a property, a room, a field of view of the first camera 110a, a field of view of the second camera 110b, a field of view of another sensor, or the like) based on data from the first camera 110a, the second camera 110b, and/or other sensors.

The memory 112b of the second camera 110b may include an AI model 113b. The AI model 113b may be similar to the AI model 113a. In some implementations, the AI model 113a and the AI model 113b have the same parameters. In some implementations, the AI model 113a and the AI model 113b are trained together using data from the cameras 110. In some implementations, the AI model 113a and the AI model 113b are initially the same but are independently trained by the first camera 110a and the second camera 110b, respectively. For example, the first camera 110a may be focused on a porch and the second camera 110b may be focused on a driveway, causing data collected by the first camera 110a and the second camera 110b to be different, leading to different training inputs for the first AI model 113a and the second AI model 113b. In some implementations, the AI models 113 are trained using data from the server 120. In an example, the AI models 113 are trained using data collected from a plurality of cameras associated with a plurality of buildings. The cameras 110 may share data with the server 120 for training the AI models 113 and/or a plurality of other AI models. The AI models 113 may be trained using both data from the server 120 and data from their respective cameras.

The cameras 110, in some implementations, may determine a likelihood that the object 170 (e.g., a package) is within an area (e.g., a portion of a site or of the environment 100) based at least in part on audio data from microphones 118, using sound analytics and/or the AI models 113. In some implementations, the cameras 110 may determine a likelihood that the object 170 is within an area based at least in part on image data using image processing, image detection, and/or the AI models 113. The cameras 110 may determine a likelihood that an object is within an area based at least in part on depth data from the radar sensors 114, a direct or indirect time of flight sensor, an infrared sensor, a structured light sensor, or other sensor. For example, the cameras 110 may determine a location for an object, a speed of an object, a proximity of an object to another object and/or location, an interaction of an object (e.g., touching and/or approaching another object or location, touching a car/automobile or other vehicle, touching or opening a mailbox, leaving a package, leaving a car door open, leaving a car running, touching a package, picking up a package, or the like), and/or another determination based at least in part on depth data from the radar sensors 114.

The sensors, such as cameras 110, radar sensors 114, microphones 118, door sensors, window sensors, or other sensors, may be configured to detect occupancy. For example, the microphones 118 may be configured to sense sounds, such as voices, broken glass, door knocking, or otherwise, and an audio processing system may be configured to process the audio so as to determine whether the captured audio signals are indicative of the presence of a person in the environment 100 or structure 130.

A user interface 119 may be installed or otherwise located at the building 130. The user interface 119 may be part of or executed by a device, such as a mobile phone, a tablet, a laptop, wall panel, or other device. The user interface 119 may connect to the cameras 110 via the network 102 or the local network 105. The user interface 119 may allow a user to access sensor data of the cameras 110. In an example, the user interface 119 may allow the user to view a field of view of the image sensors 115 and hear audio data from the microphones 118. In an example, the user interface 119 may allow the user to view a representation, such as a point cloud, of radar data from the radar sensors 114. The user interface 119 may allow a user to provide input to the cameras 110. In an example, the user interface 119 may allow a user to speak or otherwise provide sounds using the speakers 116.

In some implementations, the cameras 110 may receive additional data from one or more additional sensors, such as a door sensor 135 of the door 132, an electronic lock 133 of the door 132, a doorbell camera 134, and/or a window sensor 139 of the window 136. The door sensor 135, the electronic lock 133, the doorbell camera 134 and/or the window sensor 139 may be connected to the local network 105 and/or the network 102. The cameras 110 may receive the additional data from the door sensor 135, the electronic lock 133, the doorbell camera 134 and/or the window sensor 139 from the server 120.

In some implementations, the cameras 110 may determine separate and/or independent likelihoods that an object is within an area based on data from different sensors (e.g., processing data separately, using separate machine learning and/or other artificial intelligence, using separate metrics, or the like). The cameras 110 may combine data, likelihoods, determinations, or the like from multiple sensors such as image sensors 115, the radar sensors 114, and/or the microphones 118 into a single determination of whether an object is within an area (e.g., in order to perform an action relative to the object 170 within the area). For example, the cameras 110 and/or each of the cameras 110 may use a voting algorithm and determine that the object 170 is present within an area in response to a majority of sensors of the cameras and/or of each of the cameras determining that the object 170 is present within the area. In some implementations, the cameras 110 may determine that the object 170 is present within an area in response to all sensors determining that the object 170 is present within the area (e.g., a more conservative and/or less aggressive determination than a voting algorithm). In some implementations, the cameras 110 may determine that the object 170 is present within an area in response to at least one sensor determining that the object 170 is present within the area (e.g., a less conservative and/or more aggressive determination than a voting algorithm).

The cameras 110, in some implementations, may combine confidence metrics indicating likelihoods that the object 170 is within an area from multiple sensors of the cameras 110 and/or additional sensors (e.g., averaging confidence metrics, selecting a median confidence metric, or the like) in order to determine whether the combination indicates a presence of the object 170 within the area. In some embodiments, the cameras 110 are configured to correlate and/or analyze data from multiple sensors together. For example, the cameras 110 may detect a person or other object in a specific area and/or field of view of the image sensors 115 and may confirm a presence of the person or other object using data from additional sensors of the cameras 110 such as the radar sensors 114 and/or the microphones 118, confirming a sound made by the person or other object, a distance and/or speed of the person or other object, or the like. The cameras 110, in some implementations, may detect the object 170 with one sensor and identify and/or confirm an identity of the object 170 using a different sensor. In an example, the cameras 110 detect the object 170 using the image sensor 115a of the first camera 110a and verifies the object 170 using the radar sensor 114b of the second camera 110b. In this manner, in some implementations, the cameras 110 may detect and/or identify the object 170 more accurately using multiple sensors than may be possible using data from a single sensor.

In some implementations, the cameras 110 may monitor one or more objects based on a combination of data and/or determinations from the multiple sensors (e.g., the cameras 110 or microphones 118).

The environment 100 may include one or more regions of interest, which each may be a given area within the environment. A region of interest may include the entire environment 100, an entire site within the environment, or an area within the environment. A region of interest may be within a single site or multiple sites. A region of interest may be inside of another region of interest. In an example, a property-scale region of interest which encompasses an entire property within the environment 100 may include multiple additional regions of interest within the property.

The environment 100 may include a first region of interest 140 and/or a second region of interest 150. The first region of interest 140 and the second region of interest 150 may be determined by the AI models 113, fields of view of the image sensors 115 of the cameras 110, fields of view of the radar sensors 114, and/or user input received via the user interface 119. In an example, the first region of interest 140 includes a garden or other landscaping of the building 130 and the second region of interest 150 includes a driveway of the building 130. In some implementations, the first region of interest 140 may be determined by user input received via the user interface 119 indicating that the garden should be a region of interest and the AI models 113 determining where in the fields of view of the sensors of the cameras 110 the garden is located. In some implementations, the first region of interest 140 may be determined by user input selecting, within the fields of view of the sensors of the cameras 110 on the user interface 119, where the garden is located. Similarly, the second region of interest 150 may be determined by user input indicating, on the user interface 119, that the driveway should be a region of interest and the AI models 113 determining where in the fields of view of the sensors of the cameras 110 the driveway is located. In some implementations, the second region of interest 150 may be determined by user input selecting, on the user interface 119, within the fields of view of the sensors of the cameras 110, where the driveway is located.

In a further embodiment, the cameras 110 may perform, initiate, or otherwise coordinate, a welcoming action and/or another predefined action in response to recognizing a known human (e.g., an identity matching a profile of an occupant or known user in a library, based on facial recognition, based on bio-identification, or the like) such as executing a configurable scene for a user, activating lighting, playing music, opening or closing a window covering, turning a fan on or off, locking or unlocking a door 132, lighting a fireplace, powering an electrical outlet, turning on or play a predefined channel or video or music on a television or other device, starting or stopping a kitchen appliance, starting or stopping a sprinkler system, opening or closing a garage door 103, adjusting a temperature or other function of a thermostat or furnace or air conditioning unit, or the like. In response to detecting a presence of a known human, one or more safe behaviors and/or conditions, or the like, in some embodiments, the cameras 110 may extend, increase, pause, toll, and/or otherwise adjust a waiting/monitoring period after detecting a human, before performing a deter action, or the like.

In some implementations, the cameras 110 may receive a notification from a user's smart phone that the user is within a predefined proximity or distance from the home, e.g., on their way home from work. Accordingly, the cameras 110 may activate a predefined or learned comfort setting for the home, including setting a thermostat at a certain temperature, turning on certain lights inside the home, turning on certain lights on the exterior of the home, turning on the television, turning a water heater on, and/or the like.

The security system 101 and/or the one or more security devices, in some implementations, may escalate and/or otherwise adjust an action over time and/or may perform a subsequent action in response to determining (e.g., based on data and/or determinations from one or more sensors, from the multiple sensors, or the like) that the object 170 (e.g., a human, an animal, vehicle, drone, etc.) remains in an area after performing a first action (e.g., after expiration of a timer, or the like).

In some implementations, the cameras 110 and/or the server 120 (or other device), may include image processing capabilities and/or radar data processing capabilities for analyzing images, videos, and/or radar data that are captured with the cameras 110. The image/radar processing capabilities may include object detection, facial recognition, gait detection, and/or the like. For example, the controller 106 may analyze or process images and/or radar data to determine that a package is being delivered at the front door/porch. In other examples, the cameras 110 may analyze or process images and/or radar data to detect a child walking within a proximity of a pool, to detect a person within a proximity of a vehicle, to detect a mail delivery person, to detect animals, and/or the like. In some implementations, the cameras 110 may utilize the AI models 113 for processing and analyzing image and/or radar data.

In some implementations, the security system 101 and/or the one or more security devices are connected to various IoT devices. As used herein, an IoT device may be a device that includes computing hardware to connect to a data network and to communicate with other devices to exchange information. In such an embodiment, the cameras 110 may be configured to connect to, control (e.g., send instructions or commands), and/or share information with different IoT devices. Examples of IoT devices may include home appliances (e.g., stoves, dishwashers, washing machines, dryers, refrigerators, microwaves, ovens, coffee makers), vacuums, garage door openers, thermostats, HVAC systems, irrigation/sprinkler controller, television, set-top boxes, grills/barbeques, humidifiers, air purifiers, sound systems, phone systems, smart cars, cameras, projectors, and/or the like. In some implementations, the cameras 110 may poll, request, receive, or the like, information from the IoT devices (e.g., status information, health information, power information, and/or the like) and present the information on a display and/or via a mobile application.

The IoT devices may include a smart home device 131. The smart home device 131 may be connected to the IoT devices. The smart home device 131 may receive information from the IoT devices, configure the IoT devices, and/or control the IoT devices. In some implementations, the smart home device 131 provides the cameras 110 with a connection to the IoT devices. In some implementations, the cameras 110 provide the smart home device 131 with a connection to the IoT devices. The smart home device 131 may be an AMAZON ALEXA device, an AMAZON ECHO, A GOOGLE NEST device, a GOOGLE HOME device, or other smart home hub or device. In some implementations, the smart home device 131 may receive commands, such as voice commands, and relay the commands to the cameras 110. In some implementations, the cameras 110 may cause the smart home device 131 to emit sound and/or light, speak words, or otherwise notify a user of one or more conditions via the user interface 119.

In some implementations, the IoT devices include various lighting components including the interior light 137, the exterior light 138, the smart home device 131, other smart light fixtures or bulbs, smart switches, and/or smart outlets. For example, the cameras 110 may be communicatively connected to the interior light 137 and/or the exterior light 138 to turn them on/off, change their settings (e.g., set timers, adjust brightness/dimmer settings, and/or adjust color settings).

In some implementations, the IoT devices include one or more speakers within the building. The speakers may be stand-alone devices such as speakers that are part of a sound system, e.g., a home theatre system, a doorbell chime, a Bluetooth speaker, and/or the like. In some implementations, the one or more speakers may be integrated with other devices such as televisions, lighting components, camera devices (e.g., security cameras that are configured to generate an audible noise or alert), and/or the like. In some implementations, the speakers may be integrated in the smart home device 131.

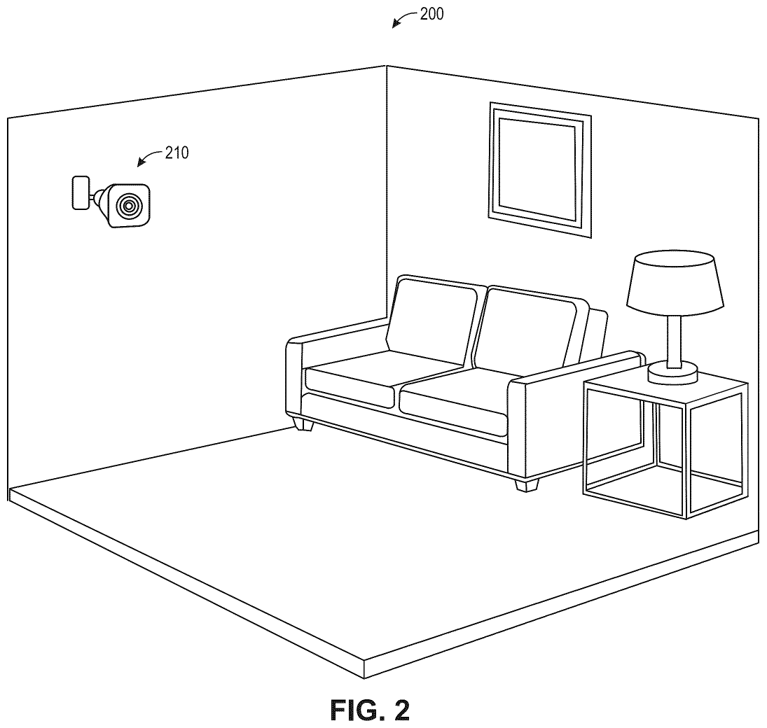

FIG. 2 illustrates an example indoor camera 210 in an indoor environment 200, such as a living room, in which the present systems and methods may be implemented. The indoor environment 200 may represent a common area within a structure or building 130, which may be a home, office, and/or the like. The indoor environment 200 may include entryways, such as doors or windows 205. The indoor environment 200 may include furniture such as a couch 202, lamp 204, and vase 206. The indoor camera 210 may be the camera 110. The indoor camera 210 may perform the features, functionalities, and capabilities of the cameras 110. The indoor camera 210 may capture audio data and visual data. The visual data may include image and/or video. The indoor camera 210 may include a processor 111, a memory 112, AI models 113, a depth sensor 114 (e.g., radar sensor 114), image sensors 115, a speaker 116, and a microphone 118 that can include and perform the features, functionalities, and capabilities of the processor 111a, memory 112a/b, depth sensor 114a/b (e.g., radar sensor 114a/b), image sensors 115, speaker 116a/b, and microphone 118a/b, respectively. The indoor camera 210 may be equipped with a battery backup system to ensure operation during power outages.

The indoor camera 210, via the microphone 118 and AI model 113, may identify or detect sounds that indicate human presence. The AI model 113 can include Convolutional Neural Networks (CNNs), Recurrent Neural Networks (RNNs), Autoencoders, SoundNet, and/or Time-Delay Neural Networks (TDNNs). The AI model 113 can be exposed and pre-trained to typical ambient sounds that constitute the normal auditory landscape of various indoor settings, including white noise, sound of human conversations, noises produced by household pets, hum of refrigerators, whirr of ceiling fans, ticking of clocks, television audio, and general household chatter. The AI model 113 may establish a baseline of what constitutes background noise within a given environment. The AI model 113 can be periodically or continuously trained through feedback loops. The AI model training may involve analyzing the actual audio data captured by the indoor camera 210 for the particular indoor environment 200 in which it operates. Through the training, the AI model 113 may dynamically adjust its baseline for normal sounds and background noise, accommodating changes in the environment such as new appliances, renovations, or alterations in indoor routines.

The AI model 113 can differentiate between sounds that signify human presence and other ambient or background noises. The AI model 113 can be exposed and pre-trained to recognizing patterns and characteristic of human activity, such as footsteps, conversation, toilets flushing, doors opening and closing, door knocks, talking, coughing, walking, or other movements. The AI model 113 can distinguish between foreground sounds (indicative of human presence) and background noise (such as the hum of appliances or traffic noise). Humans can produce sounds in specific frequency ranges and durations. The AI model 113 can analyze the frequency content and timing of captured audio to identify sounds more likely to be associated with humans. The indoor camera 210, via the AI model 113, may distinguish the normal sounds and background noise from auditory anomalies that may signal human presence. The indoor camera 210 can determine that the audio signal can be classified as an event based on a particular pattern, type, frequency, or other attribute of the sound within a period of time. These detected noise or sounds can be referred to as audio events or detected audio events. The AI model 113 can utilize the visual data of the detected audio event to classify the audio data. The indoor camera 210 may segment the signal to extract or define a time period, which may be a predetermined period of time, corresponding to that particular event. The time period of the signal can also have a corresponding video. In some configurations, upon detection of an event, the indoor camera 210 may maintain a recording from a period of time (e.g., predetermined period of time) before the event and/or continue recording for a period of time (e.g., predetermined period of time) after the event. The indoor camera 210 can execute the AI model 113 to predict the presence or absence of residents. The indoor camera 210 can execute the AI model 113 to predict the presence or absence of pets within a structure.

Although the example embodiment recites the use of the AI model 113 to analyze the audio and/or video data from the indoor camera 210 and output a determination of an event, it is intended that some embodiments may perform the analysis of the audio and/or video data from the camera may not utilize an AI model. Additionally, the processing of the data to detect and classify an event may occur on the indoor camera 210, on a local server, a remote server (e.g., cloud processing), or a combination of one or more of these devices, even though the example embodiment may recite performance on the camera for a simplified explanation.

The indoor camera 210 via a motorized mechanism may pan, rotate, or tilt in various directions. The indoor camera 210 may reposition itself in response to detected audio events and move, swivel, adjust its orientation, or point towards the source of the detected audio event. The indoor camera 210 may include a zoom-in or zoom-out feature. The indoor camera 210 may include a night vision mode. The AI model 113 can turn on or off the night vision mode of the indoor camera 210.

The indoor camera 210, via visual/image data (e.g., from image sensor 115) and AI model 113, may identify or detect visual data that may indicate human presence. The AI model 113 can be trained and pre-exposed to a wide range of visual data encountered in various indoor environments, such as walking, sitting, movement, and gestures indicative of human activity. The AI model 113 can establish a baseline of what constitutes normal visual activity within a given setting (e.g., presence of pets, shadows, and light changes). The AI model 113 can be periodically or continuously refined through feedback mechanisms. The training process involves analyzing the actual visual data captured by the indoor camera 210 specific to the indoor environment 200 it monitors. The AI model 113 can analyze patterns, sequences, or anomalies that strongly suggest human activity. The AI model 113 can analyze the extracted features to identify patterns consistent with human presence. This step may involve comparing the observed patterns against a trained dataset where the AI model 113 can learn to distinguish between human and non-human elements within visual data.

The indoor camera 210 can include privacy measures (e.g., a privacy mode). The privacy mode of the indoor camera 210 can process audio and visual data directly on the indoor camera 210 device and not on a cloud. In privacy mode, the indoor camera 210 may cease recording audio and visual data or employ anonymization techniques such as blurring faces or altering voices in the audio and visual data pushed to the cloud. The privacy mode can allow the indoor camera 210 to retain its functionality in detecting human presence and protect the privacy of individuals in its monitoring range. To further enhance privacy, the indoor camera 210 can be configured to anonymize any data transmitted, for example, by blurring visual elements that could identify individuals or by distorting audio to render voices unrecognizable. Despite these modifications, the data remains adequate for the indoor camera 210, via processor 111 and AI model 113, to make informed decisions about the indoor environment 200 occupancy and to manage the thermostat accordingly.

Based on the sound and/or visual data, the AI model 113 can determine the likelihood of human presence. Once human presence is detected, the AI model 113 within the camera evaluates the context, such as the time of day, the specific room occupied, and any predefined user preferences or behaviors. Based on this evaluation, the AI model 113 decides on the appropriate adjustments to be made to the thermostat settings. For instance, it may determine that the temperature should be increased or decreased for optimal comfort or energy efficiency.

The user interface 119 can allow users to customize how an automation system responds to different occupancy scenarios. Users can set preferences for temperature, lighting, and other device settings that are automatically applied when occupancy is detected. The user interface 119 may include an automation application. The indoor camera 210, the indoor camera 210 components, smart home device 131, and thermostats may transmit information and data to the user interface 119 via hardware and/or network protocols such as local networks (e.g., Wi-Fi or Ethernet), wireless capabilities, and Real Time Streaming Protocol (RTSP). The indoor camera 210 may transmit information and data to a cloud server, from where the user interface 119 can access the transmitted information and data. The user interface 119 may connect to the indoor cameras 210 and user devices (smart phone, tablet, computer, smart home device 131, etc.) via the network 102 or the local network 105 with wireless or wired connectivity. The automation application may receive information and data from the indoor camera 210 that a structure (e.g., home or office) is occupied (e.g., one or more persons are present). The automation application can process the received occupancy information to understand the context-such as the time of day and which rooms are occupied to make informed decisions about adjusting smart home devices accordingly. For example, the data from the smart thermostat may include a current or recent inside air temperature measurement, the HVAC operating mode (heating/cooling) and status (active/inactive), and maximum and minimum inside air temperature setpoints.

The automation application can send commands to adjust thermostat settings based on occupancy determinations. For example, when a room is detected as occupied during colder months, the automation application can increase the heating setpoint of the thermostat to ensure the space is comfortably warm for the occupants. When a room is detected as unoccupied, the automation application can lower the heating setpoint or switch off the heating to conserve energy. The users, via the user interface 119, can set preferences for different zones, define “comfort ranges” for temperatures, or manually override automatic adjustments when necessary.

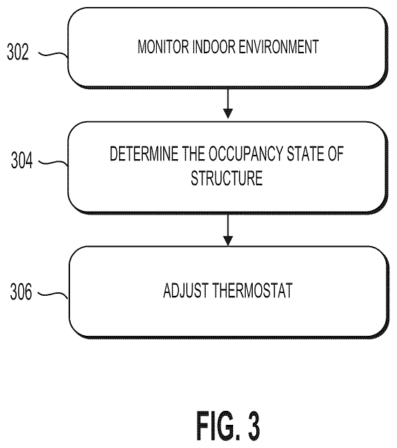

FIG. 3 illustrates a flow diagram of an example method for determining occupancy to adjust a thermostat. The method 300 may be implemented using any one or more of the components and devices detailed herein in conjunction with FIGS. 1-2. In overview, the method 300 may be performed by indoor camera 210, via visual/image data (e.g., from image sensor 115) and AI model 113. Additional, fewer, or different operations may be performed in the method 300 depending on the embodiment. At least one aspect of the operations is directed to a system, method, apparatus, or a computer-readable medium.

At step 302, the method can include monitoring the indoor environment 200 using the indoor camera 210. The indoor camera 210 can capture audio and visual data that represent environmental and occupancy-related cues. This step may include real-time or periodic analysis of the indoor environment 200 to detect changes that could indicate occupancy, such as movement, light variations, or sound.

At step 304, the indoor camera 210, via the processor 111 and AI models 113, can determine the occupancy state of the indoor environment 200. The determination of occupancy may utilize artificial intelligence and machine learning models to interpret the audio and visual data, distinguishing between human and non-human presence, and distinguishing between occupied and unoccupied states. The indoor camera 210 can predict an occupancy state of a structure (e.g., home) based on a detected sound in the audio data of the indoor environment 200 by comparing the detected sound to a sound profile for the indoor environment 200. The AI models 113 can differentiate between human and non-human activity based on the audio data or video data.

The sound profile can include a variety of sound signatures associated with different activities and presences, such as voices, footsteps, or sounds of appliances being used (e.g., television). By matching the detected sounds to the sound profile, the AI models 113 can differentiate between human and non-human activity and predict whether the structure is occupied. The AI models 113 can adapt over time, learning from new sounds and adjusting the sound profile to enhance the AI models 113 predictive accuracy. The occupancy state can be based only on the presence of a human within the structure.

At step 306, upon determining an occupancy state indicating that the indoor environment 200 is occupied, the method can include adjusting the thermostat. The indoor camera 210 can generate an instruction to a thermostat to maintain a thermostat setting for the occupied state or to adjust a thermostat setting from a configuration of an unoccupied structure to a configuration for a presence of the person. The adjustment may be based on predefined user preferences, historical data patterns, or real-time occupancy information. If the occupancy state indicates that the indoor environment 200 is unoccupied, the system may adjust the thermostat to a more energy-efficient setting to conserve energy while maintaining a baseline environmental condition. For example, if the structure is determined/predicted to be unoccupied, the indoor camera 210 can adjust the thermostat to a first thermostat setting is configured for the person away from the structure. When the structure is determined/predicted to be occupied, the indoor camera 210 can adjust the thermostat to a second thermostat. The indoor camera 210 can adjust the thermostat to a third thermostat setting if the person is predicted to be away from the structure and a pet within the structure.

The foregoing method descriptions and the process flow diagrams are provided merely as illustrative examples and are not intended to require or imply that the steps of the various embodiments must be performed in the order presented. The steps in the foregoing embodiments may be performed in any order. Words such as “then” and “next,” among others, are not intended to limit the order of the steps; these words are simply used to guide the reader through the description of the methods. Although process flow diagrams may describe the operations as a sequential process, many of the operations can be performed in parallel or concurrently. In addition, the order of the operations may be rearranged. A process may correspond to a method, a function, a procedure, a subroutine, a subprogram, and the like. When a process corresponds to a function, the process termination may correspond to a return of the function to a calling function or a main function.

The various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

Embodiments implemented in computer software may be implemented in software, firmware, middleware, microcode, hardware description languages, or any combination thereof. A code segment or machine-executable instructions may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, among others, may be passed, forwarded, or transmitted via any suitable means including memory sharing, message passing, token passing, network transmission, etc.

The actual software code or specialized control hardware used to implement these systems and methods is not limiting. Thus, the operation and behavior of the systems and methods were described without reference to the specific software code being understood that software and control hardware can be designed to implement the systems and methods based on the description herein.

When implemented in software, the functions may be stored as one or more instructions or code on a non-transitory computer-readable or processor-readable storage medium. The steps of a method or algorithm disclosed herein may be embodied in a processor-executable software module, which may reside on a computer-readable or processor-readable storage medium. A non-transitory computer-readable or processor-readable media includes both computer storage media and tangible storage media that facilitate transfer of a computer program from one place to another. A non-transitory processor-readable storage media may be any available media that may be accessed by a computer. By way of example, and not limitation, such non-transitory processor-readable media may comprise RAM, ROM, EEPROM, CD-ROM or other optical disk storage, magnetic disk storage or other magnetic storage devices, or any other tangible storage medium that may be used to store desired program code in the form of instructions or data structures and that may be accessed by a computer or processor. Disk and disc, as used herein, include compact disc (CD), laser disc, optical disc, digital versatile disc (DVD), floppy disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and/or instructions on a non-transitory processor-readable medium and/or computer-readable medium, which may be incorporated into a computer program product.

The preceding description of the disclosed embodiments is provided to enable any person skilled in the art to make or use the present disclosure. Various modifications to these embodiments will be readily apparent to those skilled in the art, and the generic principles defined herein may be applied to other embodiments without departing from the spirit or scope of the disclosure. Thus, the present disclosure is not intended to be limited to the embodiments shown herein but is to be accorded the widest scope consistent with the following claims and the principles and novel features disclosed herein.

While various aspects and embodiments have been disclosed, other aspects and embodiments are contemplated. The various aspects and embodiments disclosed are for purposes of illustration and are not intended to be limiting, with the true scope and spirit being indicated by the following claims.

What is claimed is:

1. A system, comprising:
an indoor camera configured to monitor an indoor environment of a structure, the indoor camera comprising one or more processors coupled with non-transitory memory and configured to:
capture audio data and video data of the indoor environment;
predict an occupancy state of the structure based on at least a detected sound in the audio data of the indoor environment by comparing the detected sound to a sound profile for the indoor environment; and
be responsive to predicting the occupancy state including a person at the structure, generate an instruction to a thermostat to maintain a thermostat setting for the occupied state or to adjust a thermostat setting from a configuration of an unoccupied structure to a configuration for a presence of the person.

2. The system of claim 1, wherein the indoor camera is further configured to differentiate between human and non-human activity based on the audio data and/or video data.

3. The system of claim 2, wherein the occupancy state corresponds to the presence of a human within the structure.

4. The system of claim 1, wherein the sound profile represents a sound of at least one of footsteps, a television, an appliance, or a voice.

5. The system of claim 1, wherein a first thermostat setting is configured for the person away from the structure, and a second thermostat setting is configured for the person within the structure.

6. The system of claim 5, wherein a third thermostat setting is configured for the person away from the structure and a pet within the structure.

7. The system of claim 1, wherein the occupancy state of the structure is based, at least in part, on a time of day.

8. A method, comprising:
monitoring, with an indoor camera, an indoor environment of a structure;
capturing audio data and video data of the indoor environment;
predicting an occupancy state of the structure based on at least a detected sound in the audio data of the indoor environment by comparing the detected sound to a sound profile for the indoor environment; and
responsive to predicting the occupancy state including a person at the structure, generating an instruction to a thermostat to maintain a thermostat setting for the occupied state or to adjust a thermostat setting from a configuration of an unoccupied structure to a configuration for a presence of the person.

9. The method of claim 8, further comprising differentiating between human and non-human activity based on the audio data and/or video data.

10. The method of claim 9, wherein the occupancy state corresponds to the presence of a human within the structure.

11. The method of claim 8, wherein the sound profile represents a sound of at least one of footsteps, a television, an appliance, or a voice.

12. The method of claim 8, wherein a first thermostat setting is configured for the person away from the structure, and a second thermostat setting is configured for the person within the structure.

13. The method of claim 12, wherein a third thermostat setting is configured for the person away from the structure and a pet within the structure.

14. The method of claim 8, wherein the occupancy state of the structure is based, at least in part, on a time of day.

15. A system, comprising:
an indoor camera configured to:
monitor an indoor environment of a structure;
capture audio data and video data of the indoor environment;
a thermostat configured to, in response to a determination that an occupancy state of a structure is occupied, operate in an occupied state, the occupancy state determined based on at least a detected sound in the audio data of the indoor environment by comparing the detected sound to a sound profile for the indoor environment.

16. The system of claim 15, wherein the indoor camera is further configured to differentiate between human and non-human activity based on the audio data and/or video data.

17. The system of claim 16, wherein the occupancy state corresponds to a presence of a human within the structure.

18. The system of claim 15, wherein the sound profile represents a sound of at least one of footsteps, a television, an appliance, or a voice.

19. The system of claim 15, wherein a first thermostat setting is configured for a person away from the structure, and a second thermostat setting is configured for the person within the structure.

20. The system of claim 19, wherein a third thermostat setting is configured for the person away from the structure and a pet within the structure.
